(19) United States
(12) Patent Application Publication
(10) Pub. No.: US 2012/0314102 A1
(43) Pub. Date: Dec. 13, 2012

(54) METHOD FOR STORING IMAGE

(75) Inventor: Yung-Tsung Wang, Taichung City (TW)

(73) Assignee: ALTEK CORPORATION, Hsinchu City (TW)

(21) Appl. No.: 13/241,245

(22) Filed: Sep. 23, 2011

(30) Foreign Application Priority Data
Jun. 9, 2011 (TW) 100120193

(51) Int. Cl. H04N 5/76

(52) U.S. Cl. 348/231.2; 348/E05.031

(57) ABSTRACT

A method for storing image including the following steps is provided. Firstly, a raw image is obtained. Next, an image compressing process is executed for the raw image in a memory to obtain a compressed image and a plurality of compressed image information. Then, the compressed image and the plurality of compressed image information are moved to a continuous section of the memory. Afterwards, content of the continuous section is written to a compressed image file of a memory card.

### CROSS-REFERENCE TO RELATED APPLICATION

This application claims the priority benefit of Taiwan application serial no. 100120193, filed on Jun. 9, 2011. The entirety of the above-mentioned patent application is hereby incorporated by reference herein and made a part of this specification.

### BACKGROUND OF THE INVENTION

1. Field of the Invention

The present invention relates to a method for processing image and particularly to a method for storing image.

2. Description of Related Art

With the rapid progress in science and technology, recording the daily life events by using the digital camera instead of a film camera has become more and more popular. Regarding the performance of the digital camera, the time to store the image is one of the most important parts, and the kind of memory card is strongly related to the image storing time. In general, the image storing time is deeply affected by the read/write characteristic of the memory card. Performance would be reduced due to the increment of the storing image time especially if a slow memory card having a slow accessing speed is used in the camera.

In general, a joint photographic experts group (JPEG) format image is formed in a digital camera according to an image processing process after capturing an image. Taking the JPEG format of the multi picture format (MPF) as an example, the process has to compress the raw data of YCC420 and operate batch storing at the same time. The process is described as follows.

First, the digital camera performs the JPEG compression till the image compressing process is completed. During the JPEG compression, the digital camera simultaneously operates batch writing data to the memory card, herein the data is written once in every 128 KB. When the JPEG compression is completed, the rest file which does not reach 128 KB is written to the memory card. And then, the application marker segment (APP1) and the video graphic array (VGA) data are written to the memory card. Finally, the exchangeable image file (EXIF) data is written to the memory card.

Table 1 and Table 2 respectively illustrate the results of 10 times tests of data writing of the conventional processing process being applied to a slow memory card (SanDisk microSD 2G) and a quick memory card (Transcend microSD 4G class6). Herein, storing time illustrates the total time for batch writing the compressed image of 3 MB to the memory card, and writing the APPI, VGA data and EXIF data to the memory card. Processing time illustrates the total time for the whole image processing process.

TABLE 1
The results of the storing time and the image processing time after
testing 10 times writing data by using a slow memory card.

| slow memory card | 1 | 2 | 3 | 4 | 5 | 6 |
|---|---|---|---|---|---|---|
| storing time (μs) | 1066619 | 102243166 | 1208649 | 1358918 | 1049317 | 1037872 |
| processing time (μs) | 4011566 | 3794464 | 3976197 | 4305939 | 3829437 | 3684601 |

| slow memory card | 7 | 8 | 9 | 10 | average |
|---|---|---|---|---|---|
| storing time (μs) | 1211425 | 1385711 | 1039978 | 1062836 | 1144376 |
| processing time (μs) | 3924896 | 4281524 | 3798676 | 3970124 | 3957742 |

TABLE 2
The results of the storing time and the image processing time after
testing 10 times writing data by using a quick memory card.

| quick memory card | 1 | 2 | 3 | 4 | 5 | 6 |
|---|---|---|---|---|---|---|
| storing time (μs) | 1212891 | 48846566 | 444092 | 898956 | 854919 | 425965 |
| processing time (μs) | 3450195 | 2691407 | 2567535 | 2973205 | 2844574 | 2569153 |

| quick memory card | 7 | 8 | 9 | 10 | average |
|---|---|---|---|---|---|
| storing time (μs) | 912384 | 825622 | 559967 | 874115 | 749737.6 |
| processing time (μs) | 2906646 | 2836608 | 2612549 | 3102997 | 2855487 |

When the above mentioned image processing process is applied to the slow memory card or a non secure digital high capacity (non-SDHC) memory card, it is found that the writing time is increased. If the testing is done to the files with the same size by using the slow memory card and the quick memory card, it can be significantly seen that the storing time is strongly affected by the slow memory card. In addition, the writing data length of the above mentioned batch writing often has the effect of 32 KB alignment. If the writing data length is not 32 KB alignment, the efficiency of the whole data writing would become lower. Thus, the problem of demand of 32 KB alignment in each time of data writing has to be overcome.

### SUMMARY OF THE INVENTION

The present invention provides a method for storing image which has faster storing speed.

The present invention proposes a method for storing image, including the following steps. First, a raw image is obtained. Then, an image compressing process is executed for the raw image in a memory to obtain a compressed image and a plurality of compressed image information. After that, the compressed image and the plurality of compressed image information are moved to a continuous section of the memory according to a compressed image file format. And then, a content of the continuous section is written to a compressed image file of a memory card.

According to an embodiment of the present invention, the compressed image file format is a joint photographic experts group (JPEG) format.

According to an embodiment of the present invention, the plurality of compressed image information includes an exchangeable image file (EXIF) information, a thumbnail and a video graphic array (VGA) resolution image.

According to an embodiment of the present invention, the step of moving the compressed image and the plurality of compressed image information to a continuous section includes the following steps. First, the compressed image is moved to the continuous section. Then, the thumbnail and the VGA resolution image are moved to a later position of the compressed image in the continuous section. After that, the EXIF information is moved to a former position of the compressed image in the continuous section.

According to an embodiment of the present invention, the image compressing process further includes the following steps. First, the EXIF information is produced. Then, the thumbnail is formed according to the raw image. After that, the VGA resolution image is formed according to the raw image. Then, the raw image is compressed to the compressed image.

According to an embodiment of the present invention, the resolution of the thumbnail is 160×120.

According to an embodiment of the present invention, the resolution of the VGA is 640×480.

In light of the above, in the method for storing image of the present invention, the data in the continuous section of the memory is integrally written to the memory card after the image compressing process, so that the storing speed is effectively increased. Thus, the time for image processing is significantly reduced.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a flow chart of the method for storing image according to one embodiment of the present invention.

FIG. 2 illustrates a flow chart of the method for storing image according to another embodiment of the present invention.

FIG. 3 illustrates the schematic view of the memory of the method for storing image in FIG. 2.

### DESCRIPTION OF EMBODIMENTS

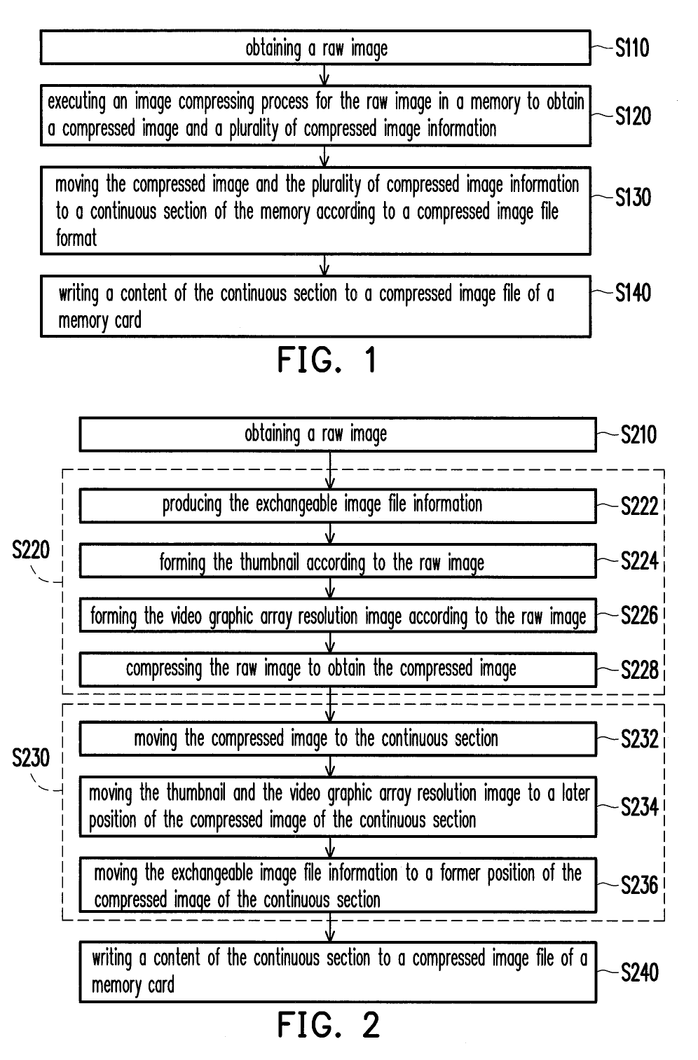

FIG. 1 illustrates a flow chart of the method for storing image according to one embodiment of the present invention. Referring to FIG. 1, first, in step S110, a raw image is obtained. In the embodiment, an image capturing device with a processing unit is used to executing the method. For instance, it can be obtained by capturing an image with a digital camera or other image capturing device. Then, in the step S120, an image compressing process for the raw image is executed in a memory to obtain a compressed image and a plurality of compressed image information. Comparing to prior art, during the image compressing process, the compressed image is not written to the memory card. After that, in the step S130, the compressed image and the plurality of compressed image information are moved to a continuous section of the memory according to a compressed image file format. Namely, a content of the compressed image file is written to the continuous section of a memory card beforehand. And then, in step S140, a content of the continuous section is written to a compressed image file of a memory card. In other words, the whole data of the content which is written to the continuous section in advance is written to the memory card.

FIG. 2 illustrates a flow chart of the method for storing image according to another embodiment of the present invention. Referring to FIG. 1 and FIG. 2, this embodiment is similar to the embodiment of FIG. 1. But for further illustration, the description will be accompanied with JPEG format. First, in step S210, a raw image is obtained. For instance, it can be obtained by capturing an image with a digital camera or other image capturing device. Then, in the step S220, an image compressing process for the raw image is executed in a memory to obtain a compressed image and a plurality of compressed image information. In present embodiment, the plurality of compressed image information may include an exchangeable image file (EXIF) information, a thumbnail, and a video graphic array (VGA) resolution image, etc. In addition, the resolution of the thumbnail is 160×120, and the resolution of the VGA is 640×480.

More specifically, the step of image compressing process S220 may include four following sub-steps S222-S228. First, in the step S222, the EXIF information is produced. Then, in step S224, the thumbnail is formed according to the raw image. After that, in step S226, the VGA resolution image is formed according to the raw image. Then, in step S228, the raw image is compressed to the compressed image.

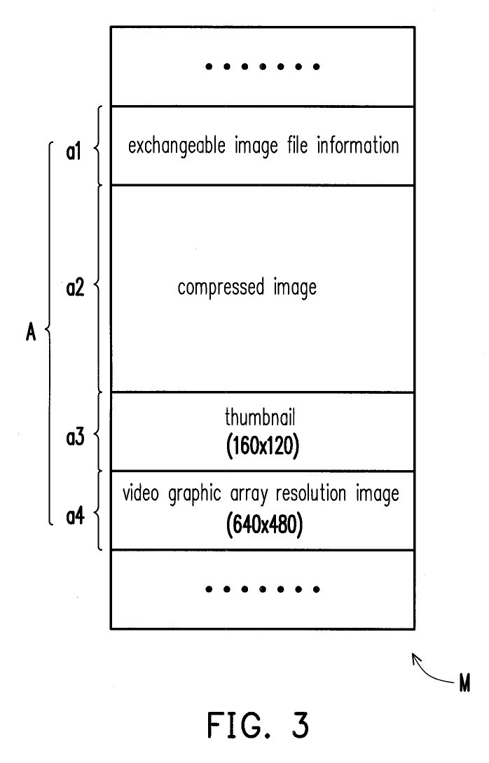

FIG. 3 illustrates the schematic view of the memory of the method for storing image in FIG. 2. Please refer to FIG. 3. After that, in the step S230, the compressed image and the plurality of compressed image information are moved to a continuous section A of the memory M according to a compressed image file format. And the continuous section A may include sequentially arranged sections a1-a4. More specifically, the step S230 may include three following sub-steps S232-S236. First, in the step S232, the compressed image is moved to the continuous section A. For example, the compressed image is moved to the section a2 of the continuous section A. Then, in the step S234, the thumbnail and the VGA resolution image are moved to a later position of the compressed image of the continuous section A. For example, the thumbnail and the VGA resolution image are respectively moved to the section a3 and the section a4. In the present embodiment, besides the thumbnail, other data of APP 1 can also be stored in the section a3. After that, in the step S236, the EXIF information is moved to a former position of the compressed image of the continuous section A. For example, the EXIF information can be moved to the sectional.

After the moving of the memory, in the step S240, the content of the continuous section A is written to a compressed image file of a memory card. In other words, the operating of batch writing of the prior art is eliminated in this embodiment, and JPEG compression and the data writing are separately operated, i.e., the data writing is operated after the JPEG compression is completed. Thus, data writing to the memory is merely operated once throughout the whole process.

Table 3 and Table 4 respectively illustrate the results of 10 times data writing tested by the present embodiment of the method for storing image being applied to a slow memory card (SanDisk microSD 2G) and a quick memory card (Transcend microSD 4G class6). Herein storing time illustrates the total time for writing the data of section A to the memory card, and processing time illustrates the total time for the whole image processing process.

TABLE 3
The results of the storing time and the image processing time
of testing 10 times data writing by using a slow memory card.

| | 1 | 2 | 3 | 4 | 5 | 6 |
|---|---|---|---|---|---|---|
| storing time (μs) | 551484 | 54351866 | 530060 | 536224 | 532989 | 539642 |
| processing time (μs) | 2808289 | 2747589 | 2722320 | 2594116 | 2603241 | 2661438 |

| | 7 | 8 | 9 | 10 | average |
|---|---|---|---|---|---|
| storing time (μs) | 538208 | 535492 | 552155 | 549957 | 540972.9 |
| processing time (μs) | 2637268 | 2591888 | 2782196 | 2843048 | 2699139 |

TABLE 4
The results of the storing time and the image processing time
of testing 10 times data writing by using a quick memory card.

| | 1 | 2 | 3 | 4 | 5 | 6 |
|---|---|---|---|---|---|---|
| storing time (μs) | 407318 | 44033866 | 420380 | 850250 | 419708 | 417786 |
| processing time (μs) | 2420166 | 2584747 | 2448853 | 2823852 | 2603821 | 2561799 |

| | 7 | 8 | 9 | 10 | average |
|---|---|---|---|---|---|
| storing time (μs) | 807373 | 832428 | 419007 | 422210 | 543679.86 |
| processing time (μs) | 2791046 | 3018280 | 2500061 | 2723907 | 2647653 |

Table 5 is the comparison of the statistic results between the prior art and the present embodiment under the same testing conditions. The conclusion is as follow:

Regarding the slow memory card, the storing time of the present embodiment is 52.73% faster than that of prior art, and the processing time of the present embodiment is 31.8% faster than that of prior art. Regarding the quick memory card, the storing time of the present embodiment is 27.48% faster than that of prior art, and the processing time of the present embodiment is 7.28% faster than that of prior art.

TABLE 5
Efficiency Comparison of the prior art and the present embodiment.

| | memory card | | | |
|---|---|---|---|---|
| | slow memory card | | quick memory card | |
| | time | | | |
| | storing | processing | storing | |
| | time (μs) | time (μs) | time (μs) | processing time (μs) |
| prior art | 1,144,376 | 3,957,742 | 749,737.6 | 2,855,487 |
| present | 540,972.9 | 2,699,139 | 543,679.8 | 2,647,653 |
| embodiment | | | | |

In light of the foregoing, in the method for storing image of the present invention, the data of the continuous section of the memory is integrally written to the memory card after the image compressing process, so that the storing speed is effectively increased. Thus, the time for image processing is significantly reduced so that the efficiency of the digital camera or the image capturing device can be improved. In addition, the efficiency of the slow memory card can be improved to be close to the efficiency of the quick memory card in the present invention. Thus, the obstacle due to the memory card speed can be improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for storing image, suitable for an image capturing device, comprising:
obtaining a raw image;
executing an image compressing process for the raw image in a memory to obtain a compressed image and a plurality of compressed image information;
moving the compressed image and the plurality of compressed image information to a continuous section of the memory according to a compressed image file format; and
writing a content of the continuous section to a compressed image file of a memory card.

2. The method for storing image according to claim 1, wherein the compressed image file format is a joint photographic experts group format.

3. The method for storing image according to claim 1, wherein the plurality of compressed image information comprises an exchangeable image file information, a thumbnail and a video graphic array resolution image.

4. The method for storing image according to claim 3, wherein the step of moving the compressed image and the plurality of compressed image information to the continuous section comprises:
moving the compressed image to the continuous section;
moving the thumbnail and the video graphic array resolution image to a later position of the compressed image in the continuous section; and
moving the exchangeable image file information to a former position of the compressed image in the continuous section.

5. The method for storing image according to claim 3, wherein the image compressing process comprises:
producing the exchangeable image file information;
forming the thumbnail according to the raw image;
forming the video graphic array resolution image according to the raw image; and
compressing the raw image to the compressed image.

6. The method for storing image according to claim 3, wherein a resolution of the thumbnail is 160×120.

7. The method for storing image according to claim 3, wherein a resolution of the video graphic array is 640×480.
